(19) United States
(12) Patent Application Publication
(10) Pub. No.: US 2005/0175089 A1
(43) Pub. Date: Aug. 11, 2005

(54) Method of processing digital images for low-rate applications

(75) Inventor: Joel Jung, Guyancourt (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/512,622

(22) PCT Filed: Apr. 22, 2003
(86) PCT No.: PCT/IB03/01584

(30) Foreign Application Priority Data
Apr. 30, 2002 (FR) 0205435

(51) Int. Cl. H04N 7/12

(52) U.S. Cl. 375/240.03; 375/240.24; 375/240.16

(57) ABSTRACT

The invention relates to a method of processing a digital image encoded and decoded in accordance with a pixel-block encoding technique, suitable for supplying a motion vector per block of pixels and a quantization step per image. Said method comprises a step of selecting said decoded image if its quantization step is larger than a predetermined threshold, and a step of detecting pixel blocks having a secondary grid. Said detection step comprises a sub-step of detecting a uniform block of the decoded image, a sub-step of selecting a uniform block of non-zero motion and with an amplitude which is smaller than a predetermined amplitude threshold, and a sub-step of localizing a secondary grid within a uniform block selected as a function or its motion vector. Such a method has the advantage that the performance of a method of correcting block effects or evaluating the quality of said decoded image is enhanced. Moreover, said method has a small complexity, which renders it possible to use it in real time in portable multimedia apparatus.

The invention relates to a method of processing a digital image encoded and decoded in accordance with a pixel-block encoding technique, said technique being suitable to provide a motion vector per block of pixels and a quantization step per image.

The invention also relates to a post-processing device using such a method.

The invention also relates to a video decoder and a video encoder using such a post-processing device.

The invention further relates to a portable apparatus comprising such a video decoder.

The invention also relates to a computer program using such a method.

Finally, the invention relates to a signal intended to convey such a program.

The invention notably finds its application in the processing of digital images which are encoded and decoded at a low rate in accordance with an encoding technique such as MPEG-4 or JVT (Joint Video Team).

Because of the growing need to transmit and store digital data, the compression techniques or, in other words, the techniques of encoding digital image sequences have become widespread. The most conventional techniques of compressing image sequences such as those defined by the MPEG standard (Motion Picture Expert Group), or ITU-T VCEG, use a motion compensation based on a block-matching algorithm and a block transform, for example, the discrete cosine transform or DCT. The sequence of images is divided into groups of images and such a group comprises an intraframe, or I frame, encoded in an independent manner, followed by several predicted frames encoded in a differential manner with respect to the preceding or subsequent frame. The block transform has the advantage that it provides strong compression rates. In contrast, the subsequent quantization step creates block effects in the decoded digital images, which leads to a degradation of their quality. Indeed, the quantization is coarser as the encoding rate is smaller. Consequently, the degradation due to the quantization step may range from an imperceptible level, when the encoding rate is high, to an annoying level, when it is low.

To remedy this problem, numerous techniques of post-processing said decoded digital images have been developed so as to correct said block effects. The blocks of 8×8 pixels used for encoding a digital image form a grid on this image, which is referred to as principal grid. The block effects appear on this grid. The majority of techniques for correcting blocks use the hypothesis that the position of said grid on the decoded image is known and remains fixed throughout the sequence of images.

Unfortunately, this hypothesis is not always true. For reasons of D/A and A/D conversions (for example, for the transmission of the sequence of encoded images or within a television) and subsequent to the use of possible pre-processing algorithms for the digital image sequence, an original image may turn out to be shifted by several pixels and the size of the principal grid may be modified. Now, the decoder does not have any information on this subject. One consequence of such a phenomenon is that the effectiveness of the block correction techniques is directly affected.

To obviate this problem, techniques for detecting the principal grid of a decoded digital image have been developed, for example, a method of detecting three regular grid sizes based on blocks of 8×8, 10-11×8 and 12×8 pixels, and described in the international application WO 01/20912.

It is an object of the invention to propose a solution for detecting the presence of a secondary grid in a digital image which has been encoded and subsequently decoded at a low rate in accordance with a block encoding technique, which method provides a localization of said grid while keeping a small complexity.

Indeed, it is not rare that a secondary grid appears in addition to the principal grid in a digital image which has been encoded and then decoded at a low rate. This secondary grid is due to a motion compensation per block of pixels, which is susceptible of creating block effects outside the borders of the principal grid, which effects are not corrected by a too coarse quantization.

The block effects which are due to the secondary grid are not generally taken into account in the conventional post-processing techniques, which ignore the existence of said grid.

To solve such a problem, the method as described in the opening paragraph is characterized in that it comprises the steps of.
selecting said decoded image if its quantization step is higher than a predetermined threshold,
detecting blocks of pixels having a secondary grid, comprising the sub-steps of
   detecting the uniform block of the selected decoded image if said block has a pixel intensity variation which is smaller than a predetermined intensity threshold,
   selecting a uniform block if its associated motion vector is non-zero and has an amplitude which is smaller than a predetermined amplitude threshold,
   localizing a secondary grid within a selected uniform block as a function of the associated motion vector.

The method according to the invention relates to digital images which are encoded and decoded at a low rate. As has been elucidated hereinbefore, it is indeed the low rate at which the phenomenon of the secondary grid is most susceptible to appear.

A first advantage of this method is that, while it provides a localization of the secondary grid in a decoded image, it serves for pre-processing before using block-effect correction techniques or techniques of evaluating the quality of said image and provides the possibility of considerably improving the effectiveness of these low-rate techniques. Indeed, knowing the localization of the secondary grid allows a block correction technique comprising, for example, a filtering step using a filter and centering said filter on the block effects due to said secondary grid. In the case of a technique of evaluating the quality, comprising a step of counting block effects, the localization of the secondary grid allows a more precise count and thus a better evaluation of the quality of the decoded image.

A second advantage of this method is that it has a small complexity. Indeed, the selection step allows elimination of the images whose quantization step is smaller than a predetermined threshold, i.e. only the images that have been encoded and decoded in a sufficiently coarse manner are preserved. As far as the step of detecting pixel blocks is concerned, it eliminates a certain number of candidate blocks so as to finally preserve only those which are uniform and whose motion vector is non-zero and with an amplitude which is smaller than a predetermined amplitude threshold. This small complexity renders it possible to perform the method according to the invention in real time and thus use it within a decoder incorporated in a portable apparatus, such as a personal digital assistant or a mobile telephone.

The invention also relates to a device using such a method.

These and other aspects of the invention are apparent from and will be elucidated, by way of non-limitative example, with reference to the embodiment(s) described hereinafter.

In the drawings:

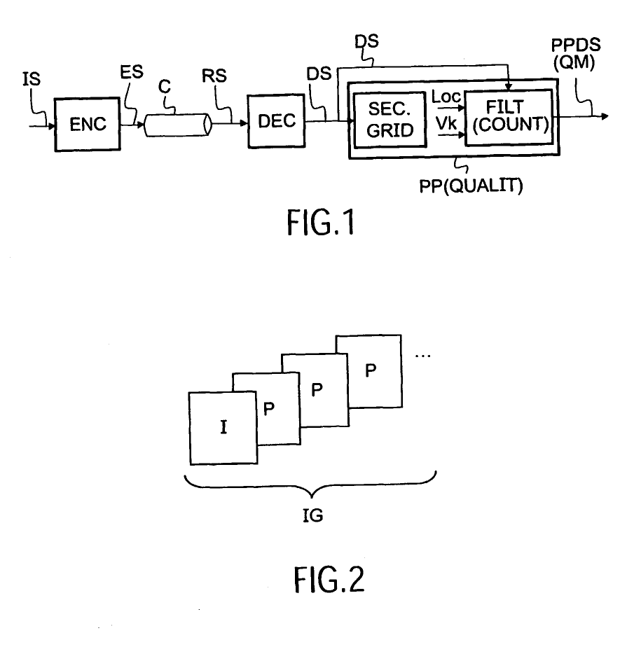

FIG. 1 is a block diagram of a complete encoding, transmission and decoding sequence of digital images, whose decoder comprises a processing device according to the invention,

FIG. 2 shows a group of images used by an encoding technique such as MPEG-4 or JVT,

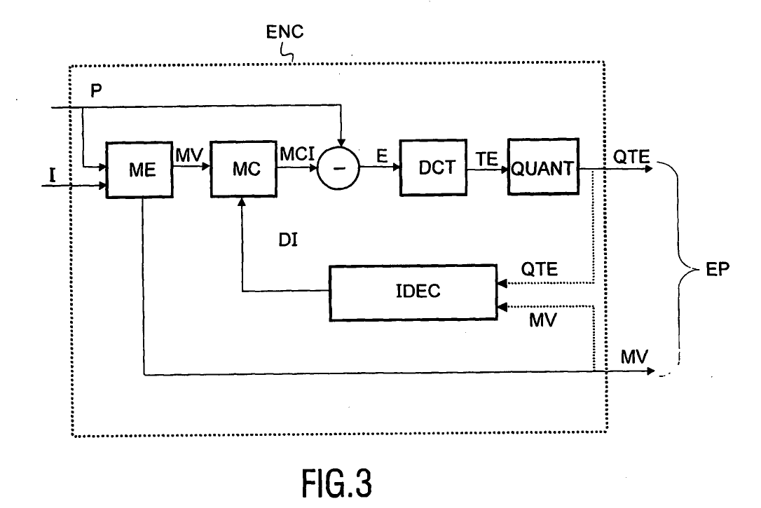

FIG. 3 is a block diagram of an encoder in accordance with an encoding technique such as MPEG-4 or JVT,

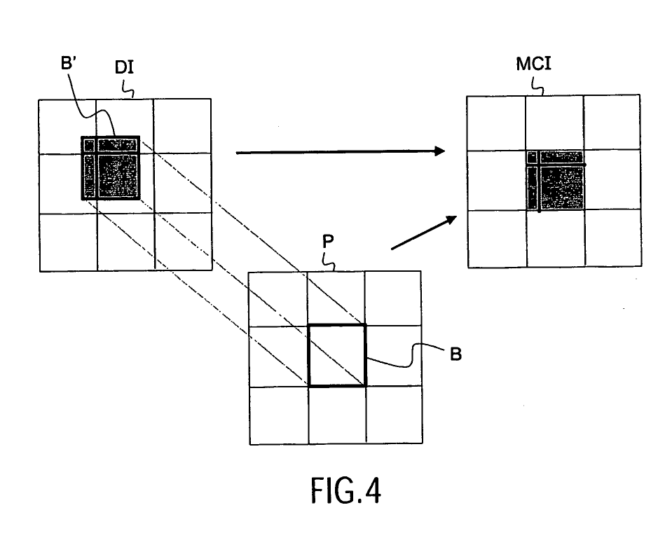

FIG. 4 shows an example of motion compensation in accordance with an encoding technique such as MPEG-4 or JVT,

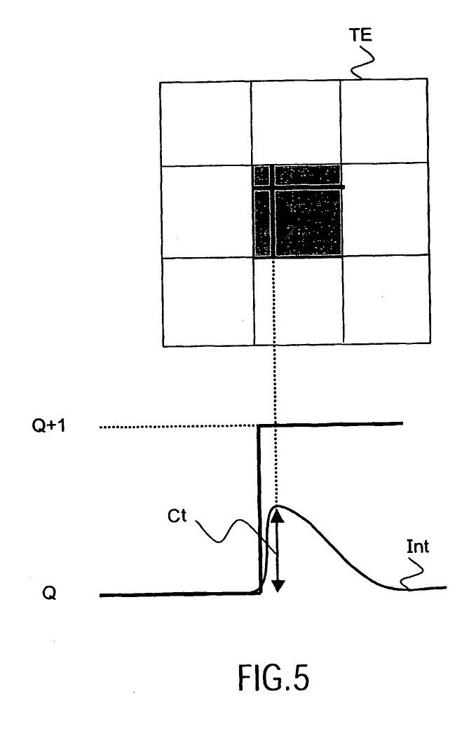

FIG. 5 shows a case of a block effect due to a secondary grid having a contrast which is smaller than the distance between two successive quantization steps,

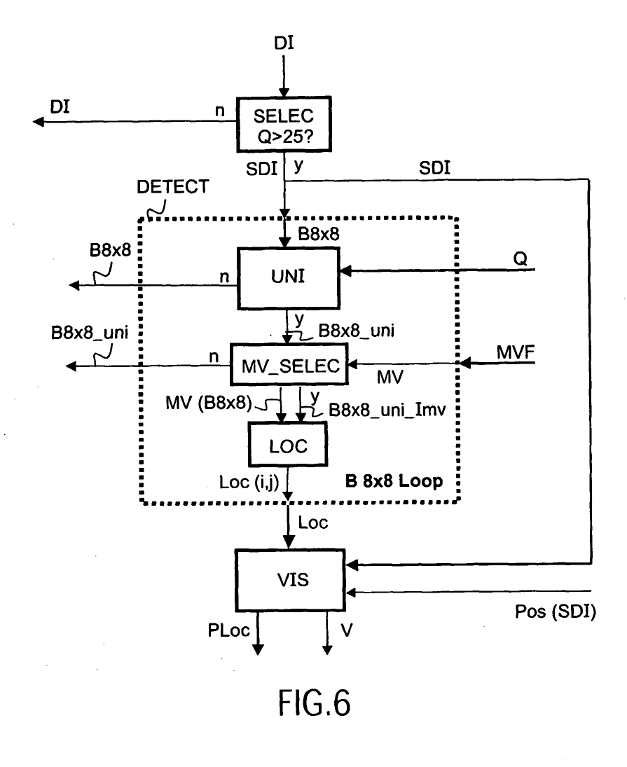

FIG. 6 is a block diagram of the processing method according to the invention,

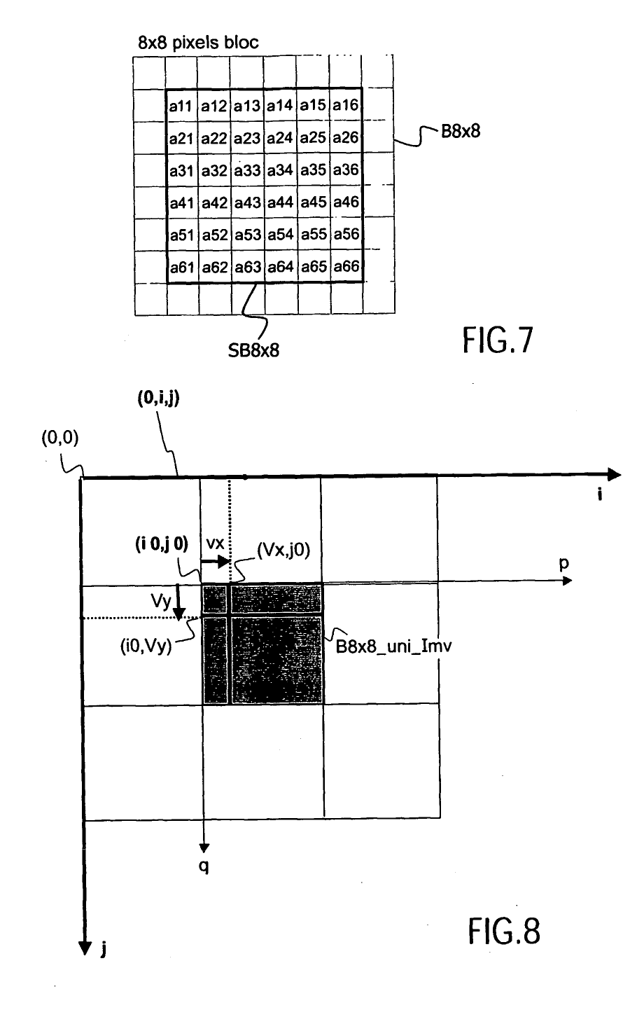

FIG. 7 describes a sub-block within a block used in the classification step according to the invention,

FIG. 8 illustrates the step of localizing the secondary grid according to the invention,

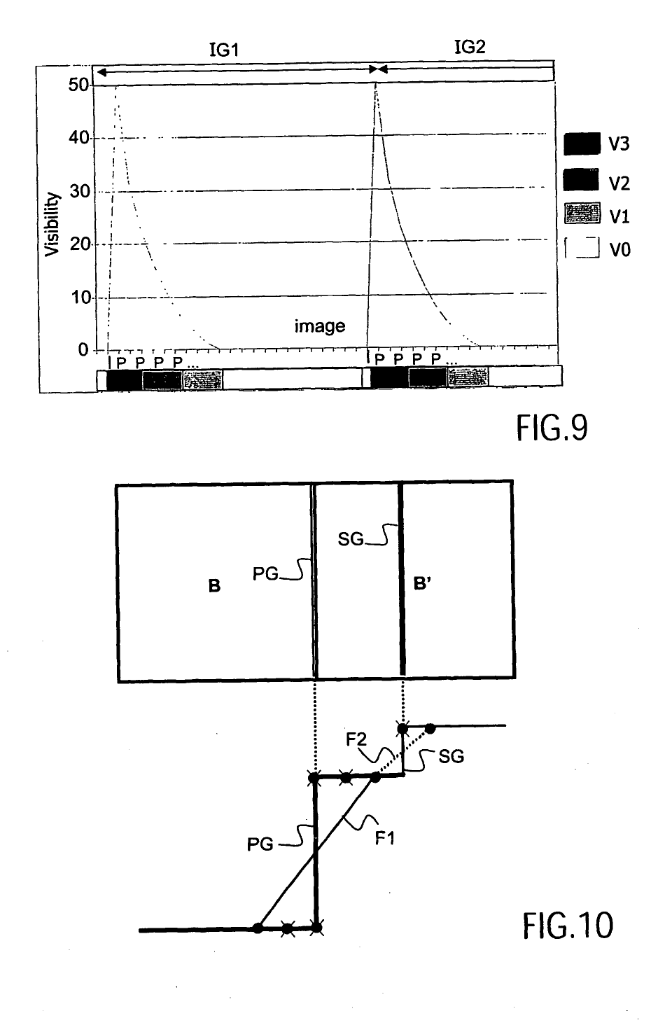

FIG. 9 shows a visibility curve of the secondary grid in a decoded image as a function of its position in a group of images,

FIG. 10 describes a correction method of filtering a pair of blocks having a primary block effect and a secondary block effect,

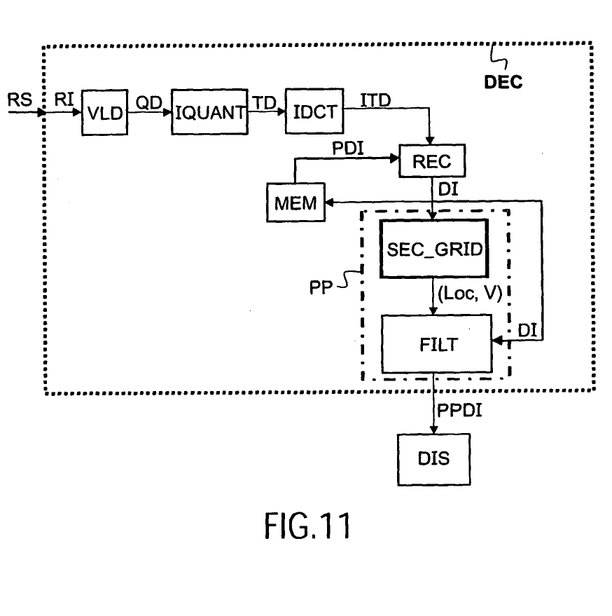

FIG. 11 is a block diagram of a video decoder comprising a processing device according to the invention,

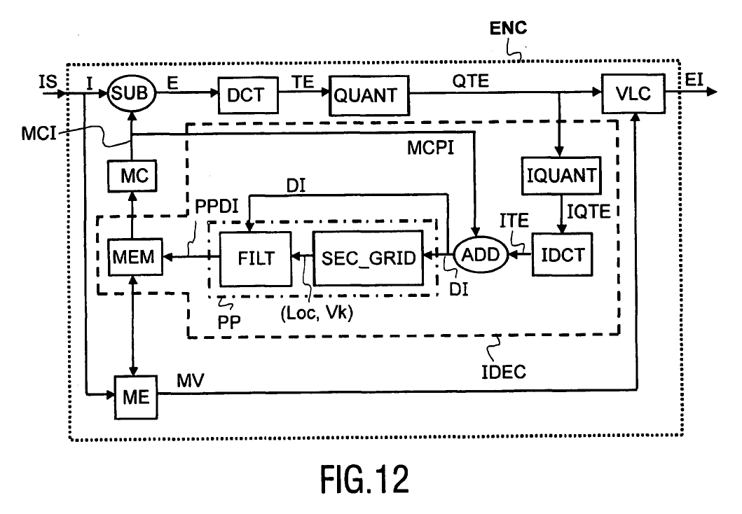

FIG. 12 is a block diagram of a video encoder comprising a processing device according to the invention.

The invention relates to a method of processing a digital image belonging to a group of images and encoded and decoded in accordance with a block encoding technique. It is applicable to any encoding technique which is suitable for supplying a motion vector per pixel block and a quantization step per image. The technique used is, for example, MPEG4 or JVT (H.26L has become JVT, which is the object of a unified standardization effort by the standardization committees ISO/IEC MPEG and ITU-T VCEG.)

FIG. 1 illustrates a complete chain of processing a sequence of digital images IS. Said chain comprises an encoder ENC which supplies a sequence of images ES encoded in accordance with a block-encoding method of the type MPEG-4 or H.26L. Said sequence ES is transmitted to a decoder DEC via a transmission channel C in the form of a received sequence of encoded images RS. Said received sequence RS is processed by the decoder DEC which supplies a sequence of decoded digital images DS to a processing device SEC. GRID according to the invention. Said device is intended to detect the possible presence of a secondary grid in a decoded digital image enumerated n of the sequence DS and to supply a localization, for example, in the form of a localization card Loc of the secondary grid in the image n and an extent of visibility Vₖ. Such a device may be integrated in a post-processing device PP comprising a filtering unit FILT intended, for example, to correct the block effects which are present in said decoded sequence DS, or in a quality evaluation device QUALIT intended to supply an extent of quality of said decoded image n, for example, as a function of a number of block effects that are present, said number being evaluated by a block-effect counter COUNT. Said post-processing device PP finally supplies a post-processed sequence of decoded images PPDS in accordance with a method which advantageously uses said localization card Loc. In the case of a quality evaluation device QUALIT, an extent of quality QM, based on the number of block effects present in the image is provided.

It should be noted that FIG. 1 constitutes only an example. It is envisageable, for example, that the post-processing device PP comprising the processing device SEC. GRID according to the invention is integrated in an encoding loop within the encoder ENC. The object of such a device is notably to transmit an encoded video data stream of the best possible quality to the decoder.

In an encoding scheme of the type MPEG-4 or JVT, the sequence of digital input images IS is divided into groups of images IG such as shown in FIG. 2. Such a group of images successively comprises an intraframe or I frame, i.e. a frame encoded in an independent manner, subsequently predicted frames P and possibly bidirectional frames B, encoded in a differential manner with respect to adjacent previous and possibly subsequent frames. In order not to uselessly complicate the description, the groups of images IG will only be considered to be of the type IPPPPPP . . . , i.e. without bidirectional frames B.

FIG. 3 illustrates the principal steps of a method of encoding a sequence of digital images, using a motion compensation and a block-frequency transform. Let us consider, for example, the first frame P subsequent to the intraframe I: a motion estimation step ME using a block matching algorithm supplies a field MVF of motion vectors from the predicted frame P and the intraframe I. Such a field comprises a motion vector MV per block of pixels in the frame P. A decoded version DI of the intraframe I supplied by a decoder IDEC within the encoder ENC is subsequently “compensated” in a motion compensation step MC based on the field of motion vectors MV, i.e. the pixel blocks of the decoded image DI are displaced as a function of said motion vectors so as to obtain an image MCI which is compensated as much as possible in accordance with certain minimization criteria of the predicted frame P. Subsequently, the difference or error E between the frame P and the compensated decoded intraframe MCI, also referred to as error image, is encoded by means of a block frequential transform, generally a discrete cosine transform or DCT, which supplies a transformed error image TE. To ensure an acceptable compression rate, said transformed error image is quantized in a quantization stage QUANT by means of a quantization step which is coarser as the encoding rate is smaller. Said quantization stage QUANT provides a quantized error image QTE.

It is thus at the level of said quantization stage that encoding errors are created.

It is this quantization stage which is at the origin of the ultimate appearance of a secondary grid in pixel blocks of certain images of the sequence at the moment of decoding. Indeed, as is shown in FIG. 4, the technique of matching blocks may choose, for a block B of the frame P, a block B′ of the frame I which overlaps four blocks of said frame I. At a low rate, it is indeed very probable that the quantized error image QTE does not provide a correction for the compensation of block B. FIG. 5 shows an intensity curve Int of a secondary grid profile which illustrates the fact that, at a low rate, a secondary block effect present in the quantized error image TE generally has an intensity variation or a contrast Cₜ which is smaller than the distance between two successive quantization steps Q and Q+1. If, under these conditions, the block B′ of the intraframe I has block effects on its borders during decoding, these block effects will propagate in the subsequent predicted frame P in an offset manner and thus cause a secondary grid to appear. It should be noted that the offset corresponds to the motion vector which has allowed the block B′ of the frame I to shift to the same position as the block B in the frame P.

The phenomenon may then easily propagate to the subsequent frames. Nevertheless, it attenuates progressively because of the motion compensations and the encoding operations for the successive error images.

It should also be noted that this secondary grid phenomenon particularly occurs in uniform zones of the image. Indeed, if the block B is present in a uniform zone, it is certainly also the case for the block B′, unless the block-matching technique is not associated with them. The probability that their difference would have an intensity which would be smaller than the quantization step is then quite greater if a difference between two textured blocks comprising, for example, object contours were concerned.

It is thus an object of the method according to the invention to detect said secondary grid in the pixel blocks of a decoded digital image. Such a method comprises three steps which are illustrated in FIG. 6. The first and the last step apply to the decoded digital image DI as a whole, and the second step applies to a block of said image.

As this is the case in the majority of standards, it will hereinafter be assumed that a block comprises 8×8 pixels which will be denoted B_{8×8}. However, the invention is evidently not limited to this particular case.

The first step is a step SELECT of selecting said decoded digital image DI as a function of its quantization step Q, intended to select said image if its quantization step is larger than a predetermined threshold. In a preferred embodiment of the invention, said threshold is fixed at 25 on a scale of values between 1 and 31, for example, for the MPEG-4 standard, i.e. only the decoded images DI whose quantization step Q is larger than 25 are selected.

Let us consider a selected decoded image SDI satisfying the afore mentioned criterion. The next step is a step DETECT of detecting pixel blocks, intended to detect the blocks B_{8×8} of said selected decoded image having a secondary grid.

In the preferred embodiment, all the pixels 8×8 of the selected image SDI are subjected to this step, but this is not obligatory. One could, for example, consider that the blocks situated in the center of the selected decoded image SDI are more important to the human eye and, for reasons of complexity, one might choose the processing operation to be limited to the processing of these blocks.

Said detection step DETECT comprises three sub-steps, also shown in FIG. 6. The first sub-step is a sub-step UNI of detecting a block of said decoded image, in which step it is decided that a block is a uniform block if said block has an intensity variation which is smaller than a predetermined intensity threshold. Let us consider a block of 8×8 pixels B_{8×8} of the selected image SDI, having intensity coefficients a_{p,q}, in which (p,q) are integers between 0 and 7. Said detection sub-step UNI considers a sub-block SB_{8×8}, of the block B_{8×8}, as shown in FIG. 7, and comprises the 6×6 central pixels of a block of 8×8 pixels B_{8×8}. It declares that the block B_{8×8} is a uniform block if the sub-block SB_{8×8} satisfies the following conditions:
|m₁−m₂|<S, with:
m₁=max{a_{p,q}}_{p=1 . . . 6,q=1 . . . 6} and m₂=min{a_{p,q}}_{p=1 . . . 6,q=1 . . . 6}.
   In this equation, S is a predefined intensity threshold, m₁ is the maximum of the coefficients a_{pq} of the sub-block SB_{8×8} and m₂ is the minimum of the coefficients a_{p,q} of the sub-block SB_{8×8}.

In the preferred embodiment of the invention, S is chosen to be equal to 3 by virtue of the known properties of the human visual system. The phenomenon of the secondary grid is actually only detectable to a human eye when the block B_{8×8} responds to the previously mentioned conditions, in other words, when the zone considered is relatively uniform. In this case, said detection step UNI supplies a block of 8×8 pixels, referred to as uniform block B_{8×8}_{_{—}}uni.

The next sub-step is a sub-step MV_SELECT of selecting a uniform block, intended to select a uniform block if its motion vector is non-zero and has an amplitude which is smaller than a predetermined amplitude threshold, as given below:

$$\{ \begin{matrix}{v}_{x}^{2} + {v}_{y}^{2} \leq Sa \\ {v}_{x}^{2} + {v}_{y}^{2} \neq 0\end{matrix}$$

in which vₓ and v_{y} are the horizontal and vertical components of the motion vector MV associated with the block B_{8×8}_{_{—}}uni.

Consequently, a block B_{8×8}_{_{—}}uni is selected if its motion vector is non-zero and has a small amplitude. An amplitude threshold Sa of 20 is chosen in the preferred embodiment. In this case, a block B_{8×8}_{_{—}}uni is selected if its motion vector MV forms part of the following list: (0,1), (0,2), (0,3), (0,4), (1,1), (1,2), (1,3), (1,4), (2,2), (2,3), (2,4), (3,3) to which it is advisable to add all the combinations with negative values of the same standard. Such a selected block will hereinafter be denoted B_{8×8}_{_{—}}uni_lmv.

At this stage, we have identified the blocks of 8×8 pixels of the selected decoded image SDI comprising block effects which are due to the presence of a secondary grid.

The next sub-step of the method according to the invention, referred to as the sub-step LOC of localizing a secondary grid within a selected uniform block B_{8×8}_{_{—}}uni_lmv is characterized in that it localizes said secondary grid within said block as a function of its motion vector MV. Let us consider, in FIG. 8, a reference frame centered on the pixel (0,0) of the decoded digital image DI and a block B_{8×8}_{_{—}}uni_lmv whose first pixel at the top and to the left is marked by the co-ordinates (i₀,j₀) in this reference frame. Knowing the components (vₓ,v_{y}) of the motion vector MV, the block effects due to the presence of a secondary grid in the block B_{8×8}_{_{—}}uni_lmv will be present in a column of pixels (i₀+vₓ,j₀+q), in which q is between 0 and 7 and in a row of pixels (p+i₀,j₀+v_{y}), in which p is between 0 and 7.

In the preferred embodiment of the invention, the positions of the pixels of the predicted frame P which are present on a secondary grid are “highlighted” in a localization card Loc, i.e. Loc(i₀+vₓ,j₀+q)=1, in which q is between 0 and 7 and Loc(i₀+p,j₀+v_{y}), in which p is between 0 and 7. Other ways of presenting the results of the localization sub-step Loc are of course also envisageable, but this mode has the advantage of being simple.

In the next step, the selected decoded image SDI as a whole is considered. It concerns a step VIS of evaluating a visibility measurement V, which is characterized in that it evaluates the visibility of the secondary grid in said selected decoded image SDI.

Such an evaluation may be made in different ways. It may be particularly based on a local measurement of intensity or contrast variation in the neighborhood of a pixel (i,j) belonging to a block B_{8×8}_{_{—}}uni_lmv such as Loc(i,j)=1. In this case, it is necessary to supply the localization card Loc from the previous sub-step to said step EVAL.

However, it should be recalled that such a block of 8×8 selected pixels B_{8×8}_{_{—}}uni_lmv has a relatively uniform texture so that one can expect that this extent of contrast is small and varies little from one block B_{8×8}_{_{—}}uni_lmv to another and is thus not very representative of the visibility of the secondary grid in a zone of the image SDI.

It is also envisageable to resort to the general knowledge about the human visual system for evaluating the visibility of the secondary grid. It indicates, for example, that a variation of contrast is much more visible in a uniform texture zone of average intensity (about 70 to 90 units of contrast out of 255 possible levels) than in very clear or, in contrast, very dark uniform zones. Such considerations may be used for standardizing a scale of visibility measurement of the secondary grid in a block B_{8×8}_{_{—}}uni_lmv.

In the preferred embodiment of the invention, said evaluation of the visibility relates to the position of the predicted frame P in a group of images IG. It does not take the local extent of contrast into account, nor the knowledge about the human visual system. On the other hand, it depends on the position Pos(SDI) of the image SDI in the group of images IG.

In accordance with an empirical study, shown in FIG. 9, it turns out that the image of the group of images IG which is most concerned by the phenomenon of the secondary grid is the first predicted frame P which follows the intraframe I. It is in this image that the secondary grid is most visible. The subsequent images also know the phenomenon but in an attenuated manner. Visibility levels may be deducted from extents of contrasts made on the block effects of the images of a group IG, as is shown in FIG. 8. In the preferred embodiment of the invention, four levels Vₖ with k from 0 to 3 have been retained. The step of evaluating the visibility measurement thus yields visibility measurement Vₖ per pixel of the image. This measurement is, for example, encoded in two bits and has the following values for a group of images comprising at least 9 predicted frames P consecutive to the first intraframe:
V3=11 for a pixel (i,j) belonging to one of the three first predicted frames P of the group of images IG, such that Loc(i,j)=1,
V2=10 for a pixel (i,j) belonging to the fourth, fifth or sixth predicted frame P of the group of images IG, such that Loc(i,j)=1,
V1=01 for a pixel (i,j) belonging to the seventh, eighth or ninth predicted frame P of the group of images IG, such that Loc(i,j)=1,
V0=00 for a pixel (i,j) belonging to the tenth image or a subsequent image or for a pixel (i,j) which is not illuminated in the localization card, i.e. for which Loc(i,j)=0.

In the preferred embodiment, the visibility measurement is utilized for weighting the values of the pixels of the localization card of the secondary grid in the decoded image. A weighted localization card Ploc of the secondary grid is supplied. In other words, for a pixel (i,j) of a block B_{8×8}_{_{—}}uni_lmv of an image SDI having a visibility Vₖ, such that (i,j) is on a secondary grid, Loc(i,j) is equal to Vₖ. In this case, the single weighted localization card PLoc comprises all the available information about the secondary grid.

An advantage of this evaluation step VIS as used in the preferred embodiment of the invention is its simplicity. It should be recalled that the object of the method of detecting the secondary grid according to the invention is its small complexity and rapid execution so that it can be accommodated in portable video decoders.

The obtained visibility measurement Vₖ combined with the localization card Loc is in conformity with the principal object of the method according to the invention, namely localizing the zones of the decoded image in which the presence of a secondary grid is visible to the human eye and disturbing, with a view to, for example, a corrective post-processing operation.

Let us consider, for example, the case of a method of post-processing block effects, which method comprises a primary filtering step. At least one filter is used in said step. As has been stated hereinbefore, such a method generally starts from the following hypotheses:
localization of the principal grid is known,
the block effects are present on the principal grid.

Said filter is thus applied to the borders between two blocks of pixels. Knowing the localization of the secondary grid, such a method of correcting block effects may integrate a second filtering step, referred to as secondary filtering step, comprising at least one filter. As is shown in FIG. 10, for a given pair of blocks of pixels (B,B′) comprising a primary block effect PG and a secondary block effect SG, the secondary filtering operation, using a filter F₂, precedes, for example, the primary filtering step, using a filter F₁. Said filter F₁ is centered on the border between the blocks B and B′, while said filter F₂ is centered on the row or column of pixels of the block marked by the localization card Loc of the secondary grid supplied by means of the method according to the invention. If a weighted localization card of the secondary grid is available, said method may even adapt the filtering operation to the extent of visibility of the block effects. It is then a question of using smoother filters for the most visible block effects.

Let us now consider a method of measuring the quality of a decoded image, which method comprises a step of counting a number of block effects in said image. Such a method generally starts from the same hypotheses as the previously mentioned post-processing method, namely that the localization of the principal grid is known and that the block effects are present on this principal grid. Said counting step counts, for example, a block effect per grid segment present in a block, or a number of pixels situated on a grid. Knowing the localization of the secondary grid, such a method of measuring the quality may thus add the block effects due to the secondary grid to the number of block effects due to the principal grid. The extent of quality obtained is then more realistic. If a weighted localization card of the secondary grid is available, such a method may even advantageously refine its extent of quality by weighting a contribution of a block effect with the calculated number of block effects as a function of the visibility associated therewith.

FIG. 11 illustrates the operation of a video decoder DEC which is suitable for supplying decoded digital images DS and comprises a processing device according to the invention. Such a video decoder comprises:
means for variable-length decoding VLD of a received encoded image RI, suitable for supplying quantized data QD, means for inverse quantization IQ of quantized data QD, suitable for supplying transformed data TD,
means for inverse discrete cosine transform IDCT of transformed data TD into inverse transformed data ITD,
means REC for reconstructing the image, using an image memory MEM, suitable for supplying a decoded image DI, based on inverse transformed data ITD and a preceding decoded image PDI,
a post-processing device PP suitable for supplying a post-processed decoded image PPDI from the decoded image DI and a localization card of the secondary grid, said card being supplied by a processing device SEC_GRID using the processing method according to the invention.

Said post-processed decoded image PPDI is subsequently supplied to a display device DISP suitable for displaying said post-processed decoded image on a screen.

FIG. 12 illustrates the operation of a video encoder ENC which is suitable for receiving a sequence of digital images IS and comprises, in the encoding loop, an internal decoding device IDEC suitable for supplying a preceding decoded image DI, followed by a post-processing device PP suitable for supplying said post-processed preceding decoded image PPDI on the basis of a localization card Loc and possibly visibility measurement Vₖ, supplied by a processing device SEC_GRID according to the invention. The video encoder ENC comprises:
means for discrete cosine transform DCT of an error image E obtained after subtraction of a preceding motion-compensated image MCI from an image I of the sequence of input images IS, into transformed data TD, using, for example, a discrete cosine transform,
means QUANT for quantizing transformed data TD, suitable for supplying quantized data QD,
means for variable-length coding VLC of quantized data, suitable for supplying an encoded image EI.
   It also comprises an internal decoding unit IDEC comprising, in series:
means for inverse quantization IQANT of the quantized data QD, suitable for supplying transformed data TD,
means for inverse discrete cosine transform of transformed data into inverse transformed data ITD,
an adder ADD of data from the device IDCT and a motion compensation device MC, suitable for supplying a reconstructed preceding image RPI,
the post-processing device PP, suitable for supplying a post-processed decoded preceding image PPDI and comprising a filtering unit FILT and a processing device SEC_GRID according to the invention, said processing device being suitable for processing a reconstructed preceding image RPI from the output of the adder ADD so as to supply a localization card Loc of the secondary grid and visibility measurement Vₖ of said grid to said filtering unit FILT,
the image memory MEM suitable for storing the images used by the motion compensation device MC, for example, a preceding decoded image PDI and the motion vectors MV from a motion estimation device ME,
a subtracter SUB suitable for subtracting the data from the motion compensation device MC of the digital input image I, the result of this subtracter SUB being supplied to the discrete cosine transform device DCT.

The processing device SEC_GRID according to the invention may thus improve the performance of a post-processing device PP and consequently that of a decoder DEC or a video encoder ENC.

The invention is not limited to the embodiments which have been described by way of example. Modifications or improvements are possible without departing from the scope of the invention. The invention is not limited to the detection of a secondary grid in images which have been encoded and subsequently decoded at a low rate in accordance with the MPEG-4 or H.26L encoding techniques. It is also applicable to images which have been decoded by means of any technique using blocks and motion compensation.

The description above with reference to FIGS. 1 to 12 illustrates rather than limits the invention. It will be evident that there are other alternatives which do not depart from the scope of the appended claims.

There are numerous ways of implementing the described functions by means of software. In this respect, FIGS. 1 to 12 are very diagrammatic and each Figure represents only an embodiment. Although a Figure shows different functions in the form of separate blocks, it does not exclude that a single item of software performs several functions. It neither excludes that a function can be performed by a software assembly.

It is possible to implement these functions by means of a digital decoding circuit incorporated in a portable multimedia apparatus, such as a personal digital assistant or a mobile telephone, which circuit is conveniently programmed. A set of instructions in a programming memory may cause the circuit to perform different operations described hereinbefore with reference to FIGS. 1 to 12. The set of instructions may also be loaded into the programming memory by reading a data carrier such as, for example, a CD-ROM. Reading may also be effected via a communication network such as the Internet. In this case, a service provider will put the set of instructions at the disposal of those interested.

Reference signs between parentheses in a claim should not be construed as limiting the claim. Use of the verb “comprise” and its conjugations does not exclude the presence of elements or steps other than those stated in the claims. Use of the indefinite article “a” or “an” preceding an element or a step does not exclude the presence of a plurality of such elements or steps.

1. A method of processing a digital image encoded and decoded (DI) in accordance with a pixel-block encoding technique, said technique being suitable to provide a motion vector (MV) per block of pixels and a quantization step (Q) per image, characterized in that said method comprises the steps of:
selecting (SELECT) said decoded image if its quantization step (Q) is higher than a predetermined threshold,
detecting (DETECT) blocks of pixels having a secondary grid, comprising the sub-steps of
detecting (UNI) the uniform block of the selected decoded image (SDI) if said block (B_{8×8}) has a pixel intensity variation which is smaller than a predetermined intensity threshold (S),
selecting (MV_SELECT) a uniform block (B_{8×8}_{_{—}}uni) if its associated motion vector (MV) is non-zero and has an amplitude which is smaller than a predetermined amplitude threshold (Sₐ),
localizing (LOC) a secondary grid within a selected uniform block (B_{8×8}_{_{—}}uni_lmv) as a function of the associated motion vector (MV).

2. A method of processing a decoded digital image (DI) as claimed in claim 1, characterized in that said method is intended to supply a localization card (Loc) of the secondary grid of said decoded digital image.

3. A method of processing a decoded digital image as claimed in claim 1, said image (DI) belonging to a group of images (IG), characterized in that said method also comprises the step of:
evaluating (VIS) a visibility measurement (Vₖ) of the secondary grid in said selected decoded image (SDI) as a function of a position of the image (SDI) in the group of images (IG).

4. A method as claimed in claim 2, characterized in that the visibility measurement (Vₖ) is intended to weight pixel values of the localization card (Loc) of the secondary grid in the selected decoded image (SDI).

5. A device for post-processing (PP) a decoded digital image (DI), the device comprising a filtering unit (FILT), characterized in that said device comprises a device (SEC_GRID) for processing said image, using a processing method as claimed in claim 1, supplying a localization (Loc) of the secondary grid in said image, said filtering unit being suitable for taking said localization into account so as to supply a processed decoded digital image (PPDI).

6. A device for measuring the quality of a decoded digital image, the device comprising a block-effect counter, characterized in that said device comprises a device (SEC_GRID) for processing said image, using a processing method as claimed in claim 1, supplying a secondary grid detection in said image, said block-effect counter being suitable for taking said detection into account so as to supply an extent of quality of the decoded digital image.

7. A video decoder (DEC) intended to supply a decoded digital image (DI) and comprising a post-processing device (PP) as claimed in claim 5, suitable for supplying a processed decoded digital image (PPDI).

8. A video encoder (ENC) intended to encode a digital input image (I), the encoder comprising internal decoding means (IDEC) supplying a decoded digital image (DI), followed by a device (PP) for post-processing said decoded image as claimed in claim 5, intended to supply a processed decoded digital image.

9. A portable apparatus comprising a video decoder as claimed in claim 7 and suitable for displaying the processed decoded digital image on a screen of said apparatus.

10. A computer program for the device for processing a digital image encoded and decoded in accordance with a block-encoding technique, the computer program comprising a set of instructions which, when loaded into a circuit of said processing device, cause said computer to perform the method as claimed in claim 1.

11. A signal intended to convey a computer program as claimed in claim 10.
